(19) United States
(12) Patent Application Publication
(10) Pub. No.: US 2026/0112728 A1
(43) Pub. Date: Apr. 23, 2026

(54) POWER STORAGE DEVICE

(71) Applicant: TOYOTA JIDOSHA KABUSHIKI KAISHA, Toyota-shi (JP)

(72) Inventor: Kei AOYAMA, Toyota-shi (JP)

(73) Assignee: TOYOTA JIDOSHA KABUSHIKI KAISHA, Toyota-shi (JP)

(21) Appl. No.: 19/228,979

(22) Filed: Jun. 5, 2025

(30) Foreign Application Priority Data
Oct. 17, 2024 (JP) 2024-181838

(51) Int. Cl. H01M 10/653; H01M 10/613; H01M 10/625; H01M 10/647; H01M 10/6551; H01M 50/209

(52) U.S. Cl. CPC H01M 10/653; H01M 10/613; H01M 10/625; H01M 10/647; H01M 10/6551; H01M 50/209

(57) ABSTRACT

A power storage device includes a power storage cell that has a first face, a cooler that has a second face facing the first face and that cools the storage cell from a side of the first face, and a thermally conductive member that is applied to the second face and that is in contact with the first face. The thermally conductive member spreads on the second face in a first direction and in a second direction that is perpendicular to the first direction. A length of the thermally conductive member in the first direction and a length of the thermally conductive member in the second direction are 80 mm or less.

### CROSS-REFERENCE TO RELATED APPLICATION

This application claims priority to Japanese Patent Application No. 2024-181838 filed on Oct. 17, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Electrified vehicles, such as battery electric vehicles, hybrid electric vehicles, and so forth, are conventionally known. Such an electrified vehicle travels by driving an electric motor with electric power that is stored in a power storage device. The power storage device includes a module in which a plurality of power storage cells is stacked. Each of the power storage cells is cooled by a cooler. A thermally conductive member is disposed between each of the power storage cells and the cooler. Usually, the cooler is coated with a thermally conductive material, following which the module is placed onto the cooler. This causes the thermally conductive material to spread out. Subsequently, the thermally conductive material is cured.

Japanese Unexamined Patent Application Publication No. 2016-203050 (JP 2016-203050 A) discloses forming a coating film by applying a coating liquid that contains a curing component onto a sheet that is relatively moving, and curing the applied coating liquid. In JP 2016-203050 A, one or three stripes of the coating film are formed along a sheet conveying direction.

### SUMMARY

When the thermally conductive material is cured, volume shrinkage (curing shrinkage) occurs due to change in crosslink density of the thermally conductive material. In particular, when the thermally conductive material is applied continuously over a long distance on the cooler, stress concentration occurs at an interface (contact area) between both end portions in a longitudinal direction of the thermally conductive material and the power storage cells. As a result, both end portions may peel off from the power storage cells.

The present disclosure provides a power storage device that is capable of suppressing a thermally conductive member from peeling off from a power storage cell.

According to one aspect of the present disclosure, a power storage device includes a power storage cell that includes a first face, a cooler that includes a second face facing the first face and that cools the power storage cell from a side of the first face, and a thermally conductive member that is applied to the second face and that is in contact with the first face. The thermally conductive member spreads on the second face in a first direction and in a second direction that is perpendicular to the first direction. A length of the thermally conductive member in the first direction and a length of the thermally conductive member in the second direction are 80 mm or less.

According to this configuration, the thermally conductive member can be suppressed from peeling off from the cooler.

Preferably, the first face is a bottom face. A plurality of the power storage cells is stacked in the first direction. The length of each of the thermally conductive members in the first direction is equal to or less than a length of the bottom face in the first direction. The length of each of the thermally conductive members in the second direction is equal to or less than a length of the bottom face in the second direction.

According to this configuration, the thermally conductive members are provided individually for each of the power storage cells, and accordingly effects of curing shrinkage can be reduced as compared to when one thermally conductive member is shared among the power storage cells.

Preferably, the thermally conductive member is made of urethane. Preferably, the length of the thermally conductive member in the second direction is 12 mm.

According to the present disclosure, the thermally conductive member can be suppressed from peeling off from the cooler.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a power storage device;

FIG. 2 is a cross-sectional view taken along line II-II in FIG. 1;

FIG. 3 is a cross-sectional view taken along line III-III in FIG. 2; and

FIG. 4 is a diagram showing a relation between a length of a thermally conductive member in a longitudinal direction and stress of the thermally conductive member.

### DETAILED DESCRIPTION OF EMBODIMENTS

An embodiment of the present disclosure will be described below with reference to the drawings. In the following description, like components are denoted by like signs. The same is true regarding names and functions thereof. Accordingly, detailed description thereof will not be repeated.

A power storage device that is described below is installed in an electrified vehicles such as a hybrid electric vehicle that is capable of traveling using motive power of at least one of a motor and an engine, and an electrified vehicle that travels under driving force that is obtained from electric energy, and so forth.

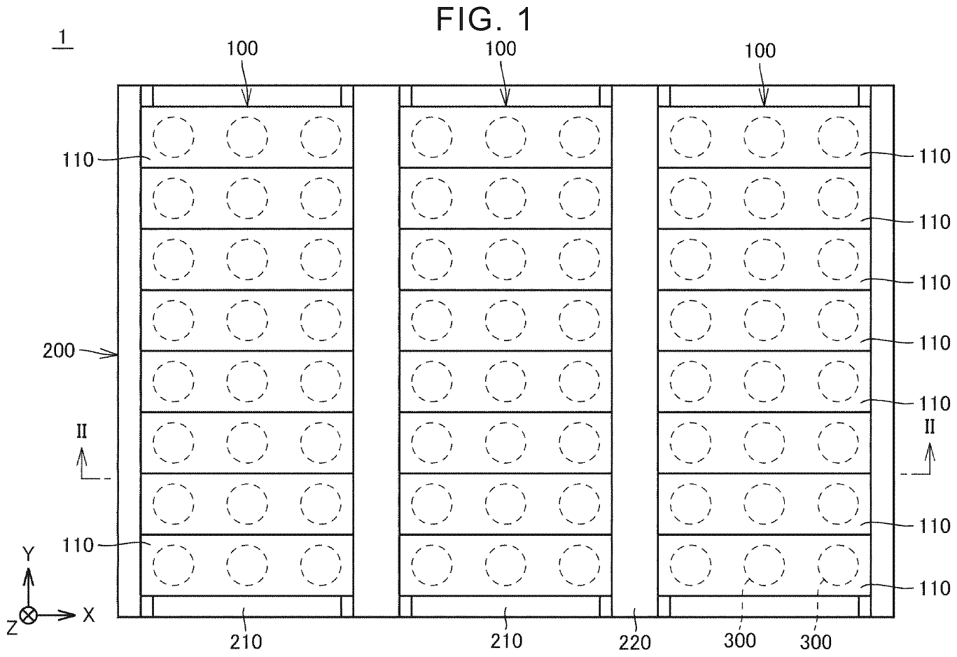

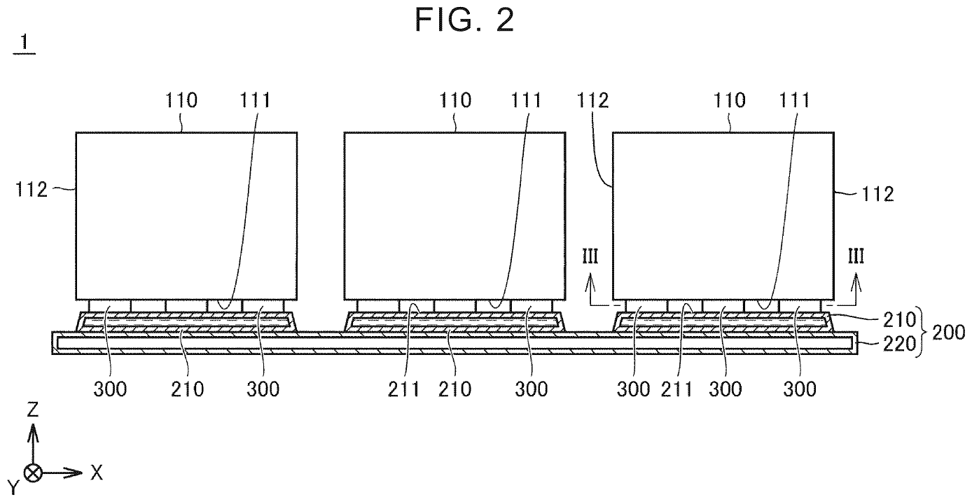

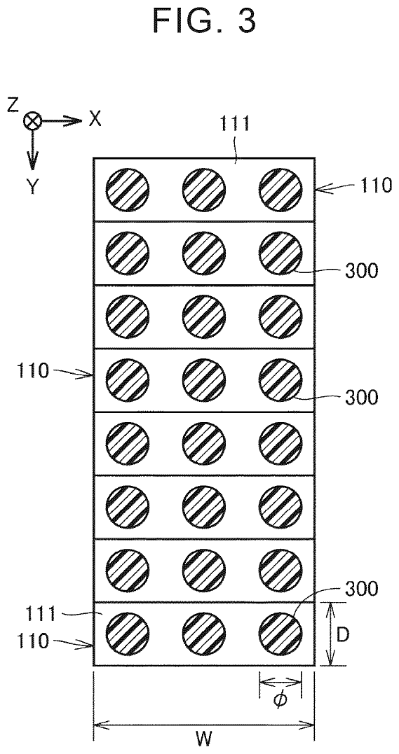

FIG. 1 is a plan view of the power storage device according to the present embodiment. FIG. 2 is a cross-sectional view taken along line II-II in FIG. 1. FIG. 3 is a cross-sectional view taken along line III-III in FIG. 2. As illustrated in FIGS. 1 to 3, the power storage device 1 includes a plurality of power storage modules 100, a cooler 200, and a plurality of thermally conductive members 300.

In this example, three power storage modules 100 are disposed at equal intervals in an X direction (second direction). Each of the power storage modules 100 includes a plurality of power storage cells 110. In this example, one power storage module 100 is formed by stacking eight power storage cells 110 in a Y direction (first direction). Each of the power storage cells 110 has a bottom face (first face) 111 and two side faces 112 of which the normal direction is the X direction. The bottom face 111 is rectangular. A lateral direction of the bottom face 111 is the Y direction, and a longitudinal direction thereof is the X direction that is perpendicular to the Y direction.

The cooler 200 cools each of the power storage modules 100. Specifically, the cooler 200 cools each of the power storage cells 110. More specifically, the cooler 200 cools each of the power storage cells 110 from the bottom face 111 side thereof. The cooler 200 cools each of the power storage cells 110 from the bottom face 111 side thereof via each of the thermally conductive members 300, which will be described later.

As illustrated in FIG. 2, the cooler 200 has top faces (second faces) 211. The top faces 211 face the bottom faces 111 of the power storage cells 110. The cooler 200 further includes a plurality of channel-forming portions 210, and a channel-forming portion 220. Note that in this example, the top faces 211 are top faces of the channel-forming portions 210.

Each of the channel-forming portions 210 is provided directly above the channel-forming portion 220. Each of the channel-forming portions 210 extends in the Y direction. In this example, three channel-forming portions 210 are disposed at equal intervals in the X direction. Antifreeze flows inside each of the channel-forming portions 210 (i.e., channel). In this example, long life coolant (LLC) is used as the antifreeze. Air flows inside the channel-forming portion 220. The cooler 200 cools each of the power storage cells 110 with the long-life coolant and the air.

The thermally conductive members 300 are disposed between the cooler 200 and the power storage cells 110. In this example, three thermally conductive members 300 are disposed between the channel-forming portion 210 and the power storage cell 110. Note that the number of the thermally conductive members 300 is not limited to this.

The thermally conductive members 300 are applied to the top faces 211 of the cooler 200. The thermally conductive members 300 are in contact with the bottom faces 111 of the power storage cells 110. In this example, three thermally conductive members 300 are in contact with the bottom face 111 of one power storage cell 110 (FIG. 3). In this example, the thermally conductive members 300 are made of urethane (specifically, manufactured by DuPont Corporation).

The thermally conductive members 300 are produced by the following processing. After a liquid (e.g., gel) thermally conductive material is applied to the top face 211 with spaces therebetween, the power storage module 100 is placed onto the cooler 200. The weight of the power storage module 100 spreads the thermally conductive material in the X and Y directions. Subsequently, the thermally conductive material is cured. This produces solid thermally conductive members 300.

Each of the thermally conductive members 300 has a cylindrical shape. Each of the thermally conductive members 300 has a thickness that is thin, and also spreads on the XY plane. The thermally conductive members 300 spread on the top face 211 in the X and Y directions. The thermally conductive members 300 spread in the Y direction and in the X direction that is perpendicular to the Y direction, due to the coating, and to the contact with the bottom faces 111. In this example, the thermally conductive members 300 have the same length in the X direction and the Y direction.

As illustrated in FIG. 3, the diameter of a bottom face of each of the thermally conductive members 300 is indicated by q. The length of the bottom face 111 of the power storage cell 110 in the Y direction is indicated by D. Similarly, the length of the bottom faces 111 in the X direction is indicated by W (>D). Note that φ indicates the diameter, and accordingly the value of φ is the length of the thermally conductive member 300 in both the X direction and the Y direction.

As illustrated in FIG. 3, in this example, when viewed from the bottom face 111 of the power storage cell 110, each of the thermally conductive members 300 is applied to the cooler 200 such that each of the thermally conductive members 300 does not protrude from the bottom face 111. Accordingly, the value of φ is equal to or less than the value of D. That is to say, the length (φ) of the thermally conductive members 300 in the Y direction is equal to or less than the length (D) of the bottom faces 111 of the power storage cells 110 in the Y direction. Note that the value of W is greater than the value of D, and accordingly the length (φ) of each of the thermally conductive members 300 in the X direction is equal to or less than the length (W) of the bottom faces 111 in the X direction.

More specifically, in this example, when focusing on one power storage cell 110, three thermally conductive members 300 are disposed in the X direction, and accordingly the value of 3φ is smaller than the value of W. In one example, the value of D is 40 mm. In one example, the value of φ is 12 mm. This is not restrictive. The value of φ can be appropriately set under conditions described below. For example, by setting the value of φ to 40 mm, the contact area between the thermally conductive member 300, and the cooler 200 and the power storage cell 110, can be increased.

Note that in this example, the thermally conductive member 300 is circular in shape when viewed from the bottom face 111 side, but is not limited thereto. The shape of the thermally conductive member 300 may be substantially rectangular when viewed from the bottom face 111. The length of the thermally conductive member 300 in the X direction and the length thereof in the Y direction do not have to be the same. Also, each of the thermally conductive members 300 may protrude from one bottom face 111 when viewed from the bottom face 111. For example, a configuration may be made in which each of the thermally conductive members 300 is in contact with multiple power storage cells 110.

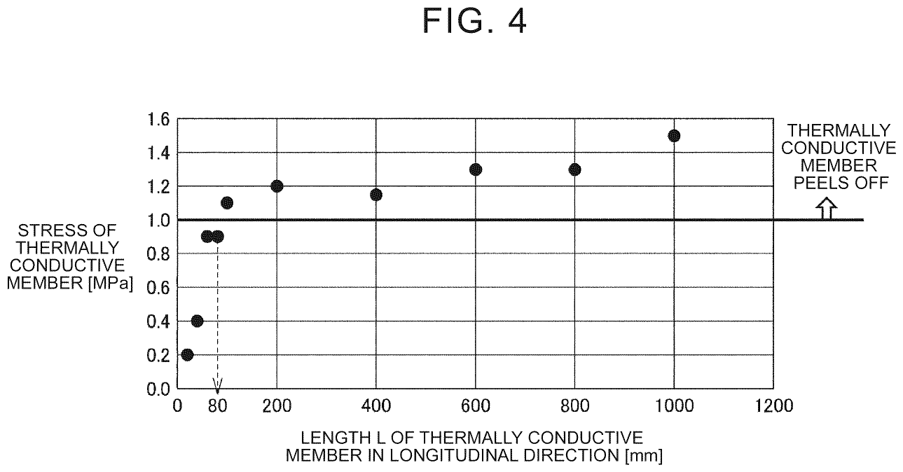

FIG. 4 is a diagram showing a relation between length in the longitudinal direction of the thermally conductive member, and stress of the thermally conductive member. Each of the ten pieces of data in FIG. 4 assumes that the length (width) in the lateral direction of the thermally conductive member is 12 mm. In FIG. 4, the length of the thermally conductive member in the longitudinal direction is indicated by L (mm). The thermally conductive member is a urethane thermally conductive member that is manufactured by DuPont Corporation, the same as that of the thermally conductive members 300. The temperature (room temperature) during coating is 25° C.

Now, the longer the length of the coating of thermally conductive material in the longitudinal direction is, the greater the volume of the thermally conductive material becomes. Accordingly, volumetric shrinkage (curing shrinkage) of the thermally conductive material during curing becomes great. Accordingly, stress caused by curing shrinkage increases. Thus, setting a coating length of the thermally conductive material in the longitudinal direction such that the stress that is generated by curing shrinkage is equal to or smaller than adhesive strength at the interface (contact area) between the thermally conductive material and the power storage cell enables the thermally conductive member to be suppressed from peeling off from the power storage cell.

As shown in FIG. 4, when the value of L is 20 mm, 40 mm, 60 mm, and 80 mm, the stress of the thermally conductive member is smaller than 1.0 MPa, which is the adhesive strength at the interface between the thermally conductive member and the power storage cell. On the other hand, when the value of L is 100 mm, 200 mm, 400 mm, 600 mm, 800 mm, and 1000 mm, the stress of the thermally conductive member is greater than 1.0 MPa.

When the stress in the thermally conductive member exceeds 1.0 MPa, the thermally conductive member will peel off from the power storage cell. Accordingly, the thermally conductive member can be suppressed from peeling off from the power storage cell as long as the value of L is set to 80 mm or less.

As described above, in the power storage device 1 of this example, setting each of the lengths of the thermally conductive member 300 in the X direction and in the Y direction thereof to 80 mm or less enables peeling of the thermally conductive members 300 from the power storage cells 110 (bottom faces 111) to be suppressed. In the above example, it is sufficient to set the value of φ illustrated in FIG. 3 to 80 mm or less.

The present disclosure is not limited to the above example, and the thermally conductive member 300 may be continuously applied to the cooler 200 by moving a nozzle that discharges the thermally conductive member 300 onto the cooler 200, relative to the cooler 200. For example, a nozzle may be used in which the length of the thermally conductive member 300 in a width direction (X direction) is 12 mm, as in the case in FIG. 4. In this case as well, the discharge of the thermally conductive material from the nozzles may be controlled such that the length of the thermally conductive members 300 in the Y direction is 80 mm or less.

### Summarization

(1) As described above, the power storage device 1 includes the power storage cells 110 having the bottom faces 111. The power storage device 1 has the top faces 211 facing the bottom faces 111, and includes the cooler 200 that cools the power storage cells 110 from the bottom face 111 side. The power storage device 1 includes the thermally conductive members 300 that are formed by being applied to the top faces 211 and are in contact with the bottom faces 111. The thermally conductive members 300 spread in the Y direction and in the X direction that is perpendicular to the Y direction. The length of the thermally conductive members 300 in the Y direction and the length thereof in the X direction are 80 mm or less. According to this configuration, the thermally conductive members 300 can be suppressed from peeling off from the power storage cells 110.
(2) The power storage cells 110 are stacked in the Y direction. The length of each of the thermally conductive members 300 in the Y direction is equal to or less than the length of the bottom face 111 in the Y direction. The length of each of the thermally conductive members 300 in the X direction is equal to or less than the length of the bottom face 111 in the X direction. According to such a configuration, thermally conductive members 300 are provided individually for each of the power storage cells 110, and accordingly the effects of curing shrinkage can be reduced as compared to when one thermally conductive member is shared among multiple power storage cells 110.
(3) The thermally conductive members 300 are made of urethane. (4) The length of the thermally conductive members 300 in the X direction is 12 mm.
(5) The power storage device 1 includes multiple thermally conductive members 300, each of which is in contact with the same bottom face 111. The thermally conductive members 300 are spaced apart from each other in the X direction. According to such a configuration, the power storage cells 110 can be cooled more efficiently than when there is only one thermally conductive member 300 in contact with one bottom face 111.

### Modifications

The length of the thermally conductive members 300 in the X direction and the length thereof in the Y direction do not have to be the same. The thermally conductive members 300 may have the lateral direction in the X direction and the longitudinal direction in the Y direction. That is to say, the thermally conductive members 300 may extend in the Y direction. In other words, the thermally conductive members 300 may spread further in the Y direction than in the X direction. In this case, it is sufficient for the length of the thermally conductive members 300 in the longitudinal direction (Y direction) in XY plan view to be 80 mm or less.

Conversely, the longitudinal direction of the thermally conductive members 300 may be the X direction, and the lateral direction thereof be the Y direction. That is to say, the thermally conductive members 300 may extend in the X direction. In other words, the thermally conductive members 300 may spread further in the X direction than in the Y direction. In this case, it is sufficient for the length of the thermally conductive members 300 in the longitudinal direction (X direction) in XY plan view to be 80 mm or less.

The thermally conductive members 300 may be disposed in a state inclined with respect to the X-axis and the Y-axis. In this case as well, it is sufficient for the length thereof in the longitudinal direction to be 80 mm or less.

An example has been described above of the configuration in which the thermally conductive members 300 are brought into contact with the bottom faces 111 of the power storage cells 110, and the power storage cells 110 are cooled from the bottom face 111 side by the cooler 200, but this is not restrictive. For example, the power storage device 1 may be configured such that the cooler cools the side faces 112 (FIG. 2) of the power storage cells 110 via the thermally conductive members.

The embodiment disclosed herein should be considered to be illustrative in all respects and not restrictive. The scope of the present disclosure is defined by the claims, and it is intended to include all modifications within the meaning and scope of the claims.

What is claimed is:

1. A power storage device, comprising:
a power storage cell that includes a first face;
a cooler that includes a second face facing the first face and that cools the power storage cell from a side of the first face; and
a thermally conductive member that is applied to the second face and that is in contact with the first face, wherein
the thermally conductive member spreads on the second face in a first direction and in a second direction that is perpendicular to the first direction, and
a length of the thermally conductive member in the first direction and a length of the thermally conductive member in the second direction are 80 mm or less.

2. The power storage device according to claim 1, wherein:
the first face is a bottom face;
a plurality of the power storage cells is stacked in the first direction;
the length of each of the thermally conductive members in the first direction is equal to or less than a length of the bottom face in the first direction; and
the length of each of the thermally conductive members in the second direction is equal to or less than a length of the bottom face in the second direction.

3. The power storage device according to claim 1, wherein the thermally conductive member is made of urethane.

4. The power storage device according to claim 1, wherein the length of the thermally conductive member in the second direction is 12 mm.
